(19) United States
(12) Patent Application Publication
(10) Pub. No.: US 2010/0090474 A1
(43) Pub. Date: Apr. 15, 2010

(54) MODULAR, COLLAPSIBLE-SAIL WINDMILL TOWER SYSTEM

(76) Inventor: MICHAEL ANGUELO, Miami Springs, FL (US)

Correspondence Address: EDAM LAW PLLC;Edmar M. Amaya Esq., InterAmerican Plaza, 701SW 27th AVE Suite GR9, Miami, FL, 33135, US

(21) Appl. No.: 12/636,547

(22) Filed: Dec. 11, 2009

Related U.S. Application Data
(63) Continuation-in-part of application No. 12/168,113, filed on Jul. 5, 2008.

(51) Int. Cl. F03D 9/00; F04D 29/38; F03B 13/00; F03D 11/00

(52) U.S. Cl. 290/55; 416/132 B; 290/54

(57) ABSTRACT

The present invention provides a modular apparatus for power generation composed of a main shaft, tubular shaft, a ratchet and one or more sails. The modular apparatus comprises a tubular shaft, wherein the tubular shaft concentrically surrounds the main shaft for rotation therearound. It also includes a ratchet, which acts as an attachment point between the main shaft and the tubular shaft and allows for free rotation of the tubular shaft in one rotational direction and engagement and rotation of the main shaft in the opposite rotational direction. The apparatus also includes at least one sail attached by a hinge to the tubular shaft and extending longitudinally for rotation therewith. A collapsible sail system with at least one hinge unit and at least one sail is also provided.

### CROSS REFERENCE TO RELATED APPLICATIONS

This application is a continuation-in-part of co-pending U.S. application Ser. No. 12/168,113, filed Jul. 5, 2008. The aforementioned application is hereby incorporated by reference in its entirety.

### STATEMENT REGARDING FEDERALLY-SPONSORED RESEARCH AND DEVELOPMENT

Not applicable.

### NAMES OF THE PARTIES TO A JOINT RESEARCH AGREEMENT

Not applicable.

### BACKGROUND OF THE INVENTION

### Field of the Invention

The present invention generally relates to the field of wind and water turbines, and more particularly, to collapsible sail, modular windmills and watermills.

Windmills can be designed to have horizontal or vertical axes of rotation. In general, vertical axis rotors have a major advantage over horizontal axis rotors in that they do not have to be turned into the wind as the direction of the wind changes. This simplifies the design requirements of the system and at the same time decreases or eliminates certain forces which may cause more stress on blades (sails), bearings, and other elements or components of horizontal axis systems.

Conventional windmills used for power generation are usually horizontal axis rotors and are made up of a rotor with three or more propeller blades (sails) facing into the wind. The propeller blades are of such an aerodynamic configuration as to provide lift force when wind contacts them—causing rotation of the rotor. The rotor must be positioned facing the wind in order to catch the wind force efficiently. Thus, when wind gusts from many different directions, a great amount of wind energy is not captured by the windmill, and subsequently not converted into electricity. Also, such windmills are generally very large and heavy and costly to maintain. Likewise, in low wind conditions, the blades (sails) of conventional windmills are not effectively put in motion—due to the amount of wind energy needed to cause movement of such a large and heavy blade.

A more practical approach to collecting wind and streaming water and fluid energy is to construct and distribute many small units, or modules, to work in concert as an array to capture renewable energy resources. Such a design could provide for wind and water and fluid energy capture devices that can be adapted over time (by adding or taking away modules) with the change in energy consumption requirements—providing cost efficiency and no downtime if a single module fails.

There is a need in the industry to provide an efficient and reliable means to capture wind and water energy from any direction or position without the requirement of repositioning based on changes in wind direction or speed or the requirement of blocking wind from the sails during part of the revolution of the windmill sails to prevent resistance. There is also a further need to provide different sized windmills, fluidmills and watermills based on need—from a single module for electricity generation at a home to the largest multi-module system for generation of electricity in towns or cities. There is also a further need to provide a windmill that works very efficiently and allows for virtually no downtime when a single module fails because such failure would not affect any other modules in the array.

### BRIEF SUMMARY OF THE INVENTION

In one embodiment, the present invention provides an apparatus for power generation comprising a main shaft; and at least one module, the module further comprising a tubular shaft, wherein the tubular shaft concentrically surrounds the main shaft for rotation therearound; a ratchet, whereby the ratchet acts as an attachment point between the main shaft and the tubular shaft and allows for free rotation of the tubular shaft in one rotational direction and engagement and rotation of the main shaft in the opposite rotational direction; and at least one sail vertically attached by a hinge to the tubular shaft and extending longitudinally thereof for rotation therewith.

In one embodiment, the present invention provides a collapsible sail system, the collapsible sail system comprising at least one hinge unit and at least one sail with a convex face and a concave face, with the hinge unit containing at least one hinge where the at least one sail moveably interfaces, whereby the hinge unit allows for the sails to collapse when incoming wind contacts the convex face and allows for the sails to fully extend when incoming wind contacts the concave face.

### BRIEF DESCRIPTION OF THE SEVERAL VIEWS OF THE DRAWINGS

The foregoing summary, as well as the following detailed description of the technology, will be better understood when read in conjunction with the appended drawings. For the purpose of illustrating the technology, embodiments of the invention are shown. It should be understood, however, that the technology is not limited to the precise arrangements and instrumentalities shown. In the drawings:

FIG. 1 depicts a side view of at least one embodiment of this invention.

FIG. 2 depicts a cross section, through section 2 of FIG. 1, of at least one embodiment of this invention, showing the arrangement of hinged sails around a tubular shaft as wind interacts with the sails from direction F.

FIG. 2B depicts a cross section, through section 2 of FIG. 1, of at least one embodiment of this invention, showing the arrangement of hinged sails around a tubular shaft as wind interacts with the sails from direction F.

FIG. 2C depicts a cross section, through section 2 of FIG. 1, of at least one embodiment of this invention, showing the arrangement of hinged sails around a tubular shaft as wind interacts with the sails from direction F.

FIG. 3 depicts a longitudinal cross section, through section 3 of FIG. 2, of at least one embodiment of this invention, showing a detailed view of the arrangement of two sails hinged to the tubular shaft.

FIG. 3A depicts an exploded view of FIG. 3 of at least one embodiment of this invention, showing a more detailed view of the ratchet and hinge attachments to the tubular shaft.

FIG. 4 depicts a detailed view, through section 4 of FIG. 3, of at least one embodiment of this invention, showing the ratchet upon engagement and rotation of the main shaft.

FIG. 4B depicts a detailed view, through section 4 of FIG. 3, of at least one embodiment of this invention, showing the ratchet in the free rotation orientation (when the tubular shaft freely rotates about the main shaft).

FIG. 5 depicts a detailed cross-section view, through section 5 of FIG. 3, of at least one embodiment of this invention, showing two main shafts interconnected.

### DETAILED DESCRIPTION OF THE INVENTION

Unless otherwise defined, all terms of art, notations and other terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the methods described, or referenced herein, are well understood and commonly employed using conventional methodology by those skilled in the art.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of ” “Consisting essentially of,” when used in the claims, shall have its ordinary meaning as used in the field of patent law.

The present invention depicts an inventive solution to the fore mentioned issues related to windmills, fluidmills and watermills. In at least one embodiment of the invention, the present invention pertains to an apparatus for power generation made up of a main shaft; and at least one module, the module further comprising a tubular shaft, wherein the tubular shaft concentrically surrounds the main shaft for rotation therearound; a ratchet, whereby the ratchet acts as an attachment point between the main shaft and the tubular shaft and allows for free rotation of the tubular shaft in one rotational direction and engagement and rotation of the main shaft in the opposite rotational directions; and at least one sail vertically attached by a hinge to the tubular shaft and extending longitudinally thereof for rotation therewith.

The term “windmill,” as used herein, can be used interchangeably with “watermill” or “fluidmill.” As would be understood by those skilled in the art, a windmill would capture wind energy, a watermill would capture water stream energy, and a fluidmill would capture fluid stream energy; however, for simplicity, the term “windmill” is used throughout the specification to describe the embodiments of the invention and would apply to a windmill, watermill, or fluidmill. As would be understood by those skilled in the art, a mill could include both compressible fluid mills and incompressible fluid mills. Mills of this invention could be used for both fluids (e.g. water) and gases (e.g. air).

It would also be understood that the term “wind,” as used herein, can be used interchangeably with “water” or “fluid.” The embodiments of the present invention would apply to wind, water, or other fluids.

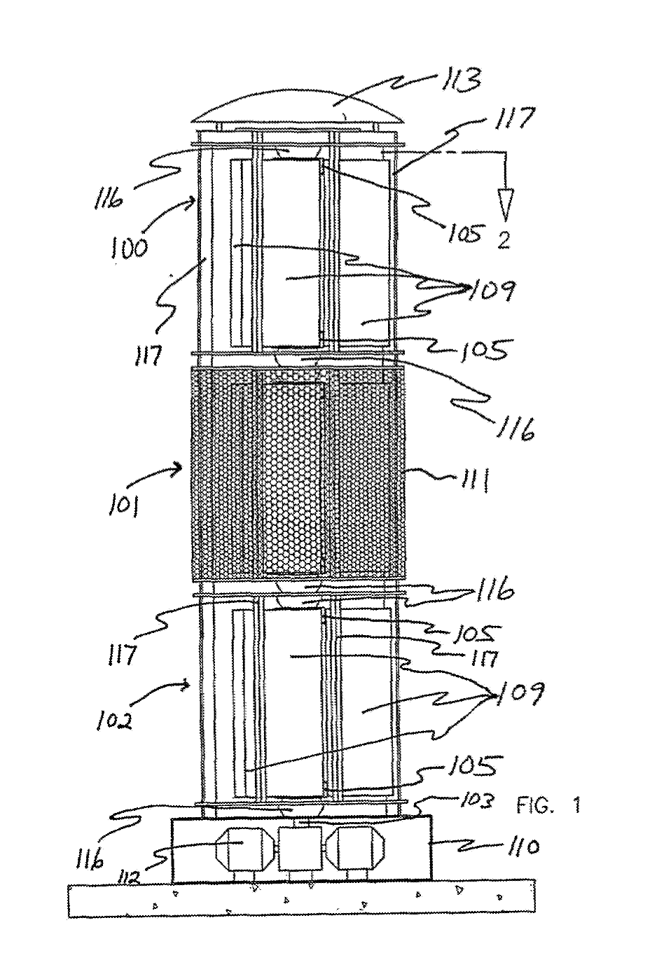

Referring now to the drawings in detail, a modular windmill is shown. This includes one or more modules, i.e. 100, 101, and 102 (the embodiment shown in FIG. 1 contains three such modules but a windmill of this invention could contain 1, or more, modules 100 stacked on top of each other.) In at least one embodiment of the invention, the present invention pertains to an apparatus for power generation made up of a main shaft 103; and at least one module 100, the module 100 further comprising a tubular shaft 104, wherein the tubular shaft 104 concentrically surrounds the main shaft 103 for rotation therearound; a ratchet 105, whereby the ratchet 105 acts as an attachment point between the main shaft 103 and the tubular shaft 104 and allows for free rotation of the tubular shaft 104 in one rotational direction and engagement and rotation of the main shaft 103 in the opposite rotational directions; and at least one sail 109 vertically attached by a hinge 106 to the tubular shaft 104 and extending longitudinally thereof for rotation therewith.

In one embodiment of the invention, the module 100 further comprises friction roll bearings 114. The friction roll bearings 114 act to prevent or minimize any friction created from the vertical gravity forces on the module 100. In another embodiment of the invention, the module 100 further comprises lateral roll bearings 115. The lateral roll bearings 115 aid in the prevention of lateral movement and friction. In one embodiment of the invention, the friction roll bearings 114 are contained in a coupling unit 116. In one embodiment of the invention, the lateral roll bearings 115 are contained in a coupling unit 116. In one embodiment of the invention, the friction roll bearings 114 and lateral roll bearings 115 are contained in a coupling unit 116. In one embodiment, the coupling unit 116 acts as the attachment point between modules 100 in a windmill array.

In one embodiment of the invention, the ratchet 105 acts as the attachment point between the main shafts 103 of subsequent modules 100 in the windmill array.

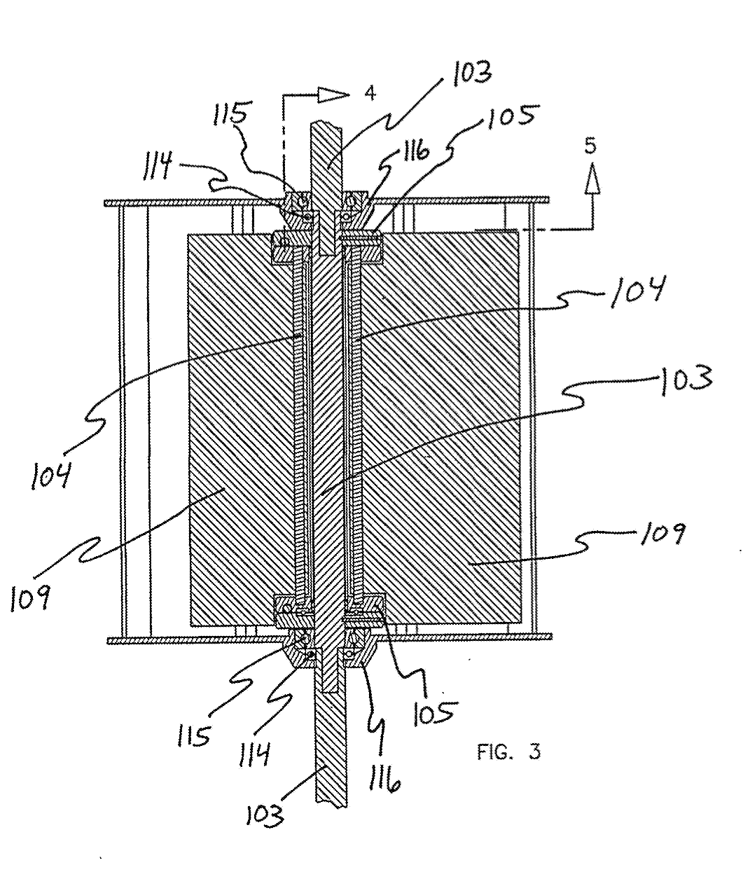

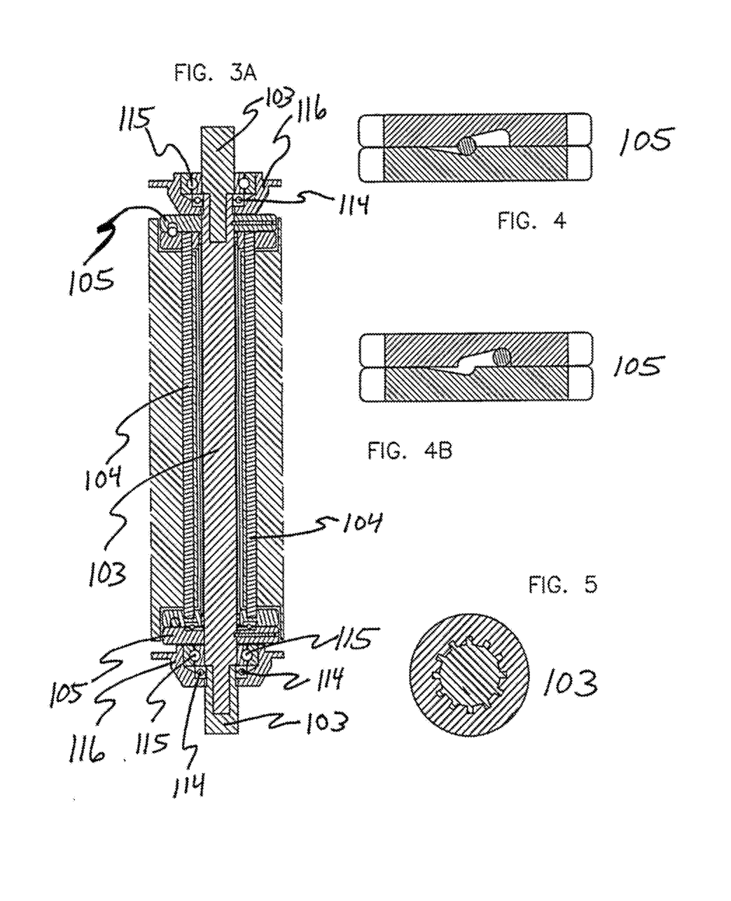

Referring to FIG. 5, in one embodiment of the invention, main shafts 103 can be modularly connected. As shown in FIG. 5, the main shafts 103 of the invention can be interconnected to create the windmill array of multiple modules 100. The main shaft 103 of a single module 100 could also be made up of multiple main shafts 103 interconnected, such that they can easily be disassembled to aid in repair and maintenance of the module 100. As shown in FIGS. 3 and 3A, the main shaft 103 of one module 100 is being interconnected with the main shaft 103 of other modules at the top and bottom of the main shaft 103 in this embodiment. As shown in FIG. 5, the interconnection involves the attachment of each of the main shafts 103 in such a way that each of the main shafts 103 operate in concert—when one main shaft 103 is engaged and rotated, all other main shafts 103 in the array are engaged and rotated. As would be understood by those in the art, the modules 100 could also be designed such that the main shafts 103 work independently and rotate independent of each other (by interconnection with ratchets.)

In one embodiment of the invention, the sails 109 comprise a convex face 107 and a concave face 108, whereby the hinge 106 allows for the sails 109 to collapse when incoming wind contacts the convex face 107 and allows for the sails 109 to fully extend when incoming wind contacts the concave face 108. The sails 109 can be made from virtually any rigid or semi-rigid material, such as metal, plastic, rubber, wood, alloys, or polymers.

In one embodiment of the invention, the sails 109 comprise a forward face and a backward face, whereby the hinge 106 allows for the sails 109 to collapse when incoming wind contacts the backward face and allows for the sails 109 to fully extend when incoming wind contacts the forward face 108. In one embodiment, the sails 109 are not curved. In another embodiment, the sails 109 can be curved.

In at least one embodiment of the invention, the module 100 may further comprise a hinge unit 112. The hinge unit 112 acts as an interface between the hinge 106 and the sails 109. One of the purposes of the hinge unit 112 is to restrict or control the amount of collapse and opening of the sails 109.

In at least one embodiment of the invention, the sails 109 collapse by the force of the incoming wind on the concave face 108. Such collapse of the sails 109 is possible due to the sails 109 being attached to a hinge 106. The torque of the rotating device also aids in the hinging and collapse of the sails 109. In other embodiments of the invention, the sails 109 may be collapsible by other mechanical or electronic means, such as by magnetic forces from magnets within, or near, the hinge 106. Other means of collapsing the sails 109 could include electronic triggering of a device to mechanically collapse the sails 109 at the designated times during revolution of the sails 109 around the main shaft 103 or mechanical triggering of the collapse by springs. In other embodiments of the invention, the sails 109 may be made of a semi-rigid material that allows bending of the sails 109 in response to wind forces. Such a semi-rigid sail design could be used with a hinge or without a hinge.

In at least one embodiment of the invention, the apparatus contains at least one base 110. A ratchet 105 can be attached to the base 110. In at least one embodiment of the invention, a module 102 can be attached to the base 110. In at least one embodiment of the invention, a flywheel can be attached to the main shaft 103. In at least one embodiment of the invention, an electric generator 112 can be operatively interfaced with the main shaft 103, allowing for rotational energy from the main shaft 103 to be transferred to the electric generator 112 for creation of electrical energy.

In at least one embodiment of the invention, a top cover 113 can be installed at the top of the uppermost module 100 to provide protection from rain, hail, objects, insects or animals from entering the windmill array from above. The top cover 113 can also serve the purpose of providing aesthetic design and appeal to the windmill array, particularly when the windmill is included in the architecture and design of a building or other construction. In one embodiment, the base 110 can also act as a storage space and/or a compartment to house the electric generator and other necessary gears.

In at least one embodiment of the invention, the ratchet 105 is selected from the group consisting of a gravity-driven bearing ratchet, a magnetic ratchet, a pawl ratchet, a sprag clutch, a cam driven ratchet, a spring-blade ratchet, and a friction ratchet. When multiple modules are used in the construction of the windmill, one may use various types of ratchets. The various modules 100, 101, and 102 can work independently, and in concert, with any combination of ratchet types.

Referring to FIG. 4, the ratchet of one embodiment of the invention is shown, through section 4 of FIG. 3, in the engaged position. In such a position, the main shaft 103 is rotated by the force of the wind on the sails 109. Referring to FIG. 4B, the ratchet of one embodiment of the invention is shown, through section 4 of FIG. 3, in the disengaged position (free rotation orientation). In the disengaged position, the tubular shaft 104 freely rotates around the main shaft 103. In one embodiment of the invention, when wind F contacts the convex face 107 of the sails 109, the sails 109 collapse. When the sails 109 are collapsed, any rotation caused by the wind force against the convex face 107 would cause disengagement of the ratchet 105 and free rotation of the tubular shaft 104 about the main shaft 103. In one embodiment of the invention, when the wind F contacts the concave face 108 of the sails 109, the sails 109 open because of the wind forces catching the face of the sail 109. The sails 109 open by the degree allowed by the hinge 106 and/or hinge unit 112 (as described herein). Once the sails 109 are opened by wind force, engagement of the ratchet 105 occurs and the main shaft 103 is rotated. If multiple modules 100, 101, and 102 are utilized in an array, it is possible that the main shaft 103 is rotating due to engagement by another module in the array. In such situations, the engagement by the current module supplements engagement of the main shaft 103 by other modules. Such situations cause an increase in the speed of rotation of the main shaft 103 or cause a decrease in the wind force required by all of the modules to maintain a given speed of the main shaft 103. A flywheel or other mechanical or electrical device can also be utilized and attached to the main shaft 103 to aid in control of the rotation of the main shaft 103. In at least one embodiment of the invention, a braking system could be interfaced with a module 100 to allow for control of the speed of rotation of the main shaft 103. In high wind conditions, it may be necessary to control the speed of rotation of the main shaft 103 to prevent damage to one or more modules in the windmill array. The braking system could also provide a means to stop the rotation of the main shaft 103 in one or more modules 100 while repairs are performed, without having to interrupt the functioning of the windmill as a whole.

In at least one embodiment of the invention, the windmill can contain a mesh 111 surrounding a module (meshed module 101). A mesh 111 can surround an individual module 100 or all of the modules of windmills of this invention that contain multiple modules. In multiple module windmills, mesh 111 could also surround certain modules in the stacked configuration but not others (see FIG. 1 for a representation of an embodiment of three modules 100, 101, and 102 containing one meshed module 101.) Any combination of meshed modules 101 can be utilized. Such flexibility in stacking meshed modules 101 and non-meshed modules, 100 and 102, allows one to cover selected modules with mesh 111 and prevent small animals, flying objects, and/or insects to enter the windmill housing and come in contact with moving sails 109, while leaving certain modules uncovered for functionality or aesthetic reasons. In one embodiment of the invention, the modules can contain support braces 117 to provide general support, bracing and/or aesthetics.

One further advantage of the present invention is that the design of the modular windmill can be integrating into the design and architecture of any building or structure. Such possibilities allow streamlined and aesthetic buildings or structures to be built with an integrated windmill for providing energy resources.

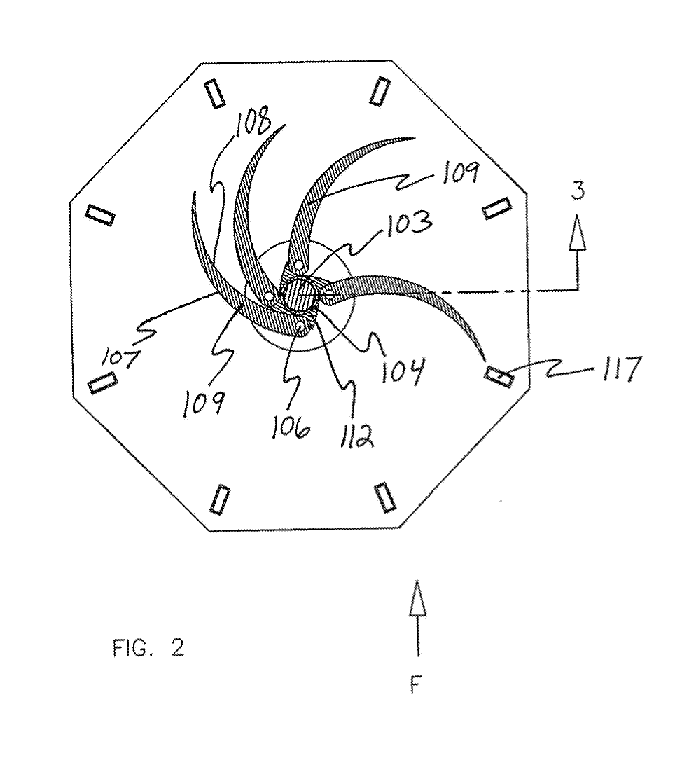

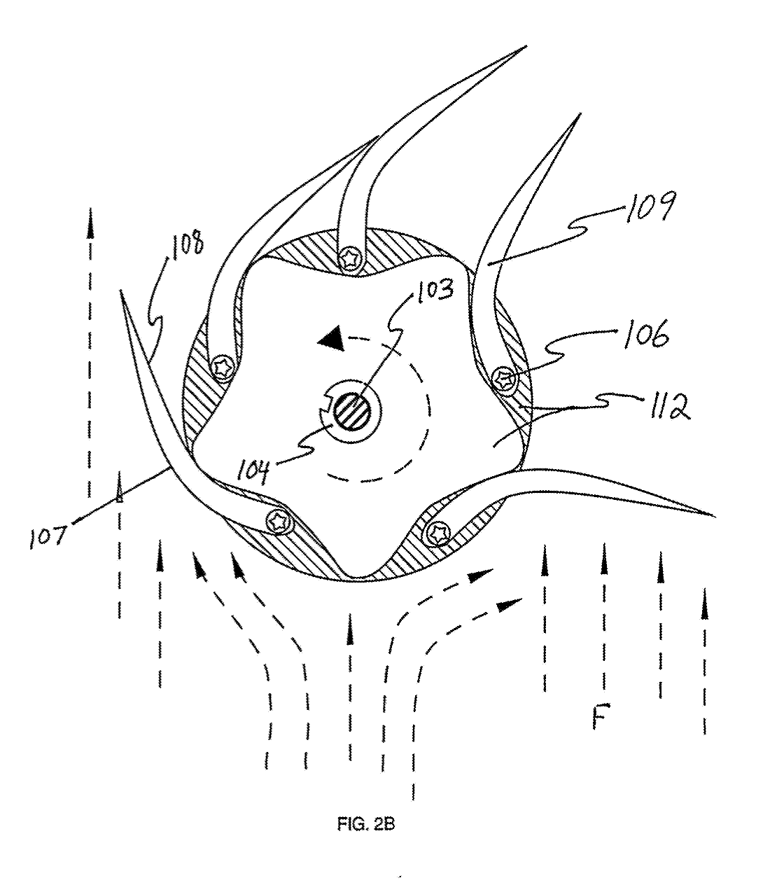

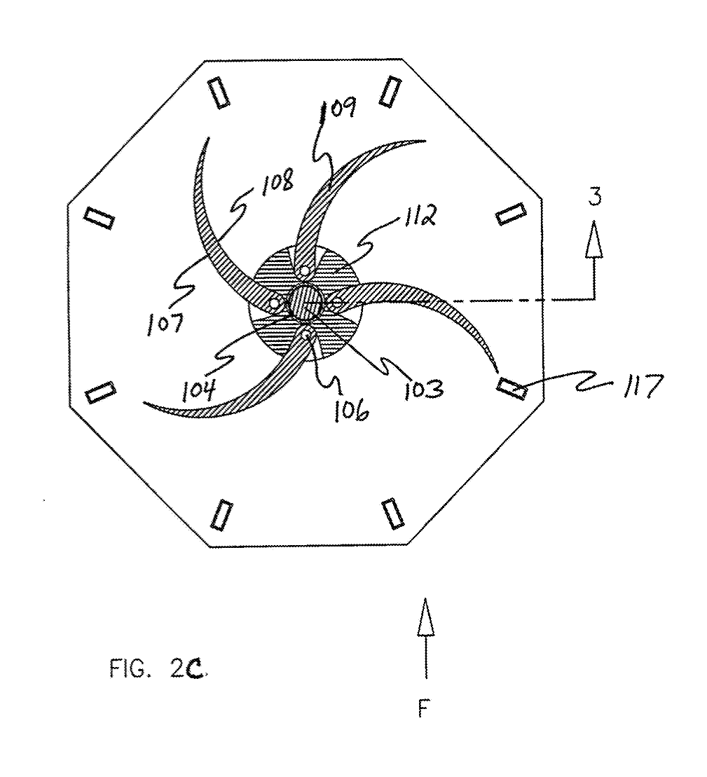

In one embodiment of the invention, the invention pertains to a collapsible sail system (see FIG. 2 and FIG. 2B and FIG. 2C), the collapsible sail system comprising at least one hinge unit 112 with at least one hinge 106; and at least one sail 109 with a convex face 107 and a concave face 108, wherein the hinge unit 112 contains at least one connection point, via at least one hinge 106, where the at least one sail 109 moveably interfaces. The hinge unit 112 allows for the sails 109 to collapse by way of the hinge 106 when incoming wind F contacts the convex face 107 and allows for the sails 109 to fully extend when incoming wind F contacts the concave face 108. The hinge unit 112 can be made up of one piece with grooves for the hinge 106 to interface with the sails 109. The hinge unit 112 is grooved, or machined, in such a way to allow unobstructed collapse (closing) of the sails 109 when the convex face 107 contacts the wind F and obstructed opening of the sails 109 when the wind F contacts the concave face 108. The obstruction of the sails 109 by the hinge unit 112 in the open position is such that the most efficient means of capturing wind force is achieved. In some embodiments, the degree of opening allowed by the hinge unit 112 can be adjusted by adjustments to the amount of groove in the hinge unit 112. In some embodiments, the hinge unit 112 can be constructed of more than one piece and assembled into a single working unit, allowing for more efficient adjustment of the unit if necessary. The hinge unit 112 can be of various designs and shapes and sizes. One of skill in the art would understand that any size, shape, or design could be used as long as the sails 109 are allowed to hinge/open/collapse as necessary for proper function. The hinge unit 112 can provide an aesthetic feature to the module.

In one embodiment of the present invention, the hinge unit 112 is constructed of a material selected from the group consisting of metal, plastic, rubber, wood, alloys, polymers and combinations thereof. The hinge unit 112 could be constructed of multiple parts, combined into a single working unit, or constructed of a single part, with grooves or edges, to effectively stop the opening and collapsing of the sails 109 at the desired positions. If the hinge unit 112 is constructed of multiple parts, each individual part could be constructed of the same material, or different materials, as the remaining parts of the hinge unit 112.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. An apparatus for power generation comprising:
(a) a main shaft; and
(b) at least one module, the module further comprising
(i) a tubular shaft, wherein the tubular shaft concentrically surrounds the main shaft for rotation therearound;
(ii) a ratchet, whereby the ratchet acts as an attachment point between the main shaft and the tubular shaft and allows for free rotation of the tubular shaft in one rotational direction and engagement and rotation of the main shaft in the opposite rotational direction; and
(iii) at least one sail vertically attached by a hinge to the tubular shaft and extending longitudinally thereof for rotation therewith.

2. The apparatus of claim 1, wherein the sails further comprise a convex face and a concave face, whereby the hinge allows for the sails to collapse when incoming wind contacts the convex face and allows for the sails to fully extend when incoming wind contacts the concave face.

3. The apparatus of claim 1, further comprising a base, wherein the ratchet is attached to the base.

4. The apparatus of claim 1, further comprising a base, wherein the module is attached to the base.

5. The apparatus of claim 1, further comprising a flywheel, wherein the flywheel is attached to the main shaft.

6. The apparatus of claim 1, further comprising an electric generator, wherein the electric generator is interfaced with the main shaft, whereby rotational energy is transferred to the electric generator.

7. The apparatus of claim 1, wherein the ratchet is selected from the group consisting of a gravity-driven bearing ratchet, a magnetic ratchet, a pawl ratchet, a sprag clutch, a cam driven ratchet, a spring-blade ratchet, a friction ratchet, and combinations thereof.

8. The apparatus of claim 1, wherein the ratchet is a gravity-driven bearing ratchet.

9. The apparatus of claim 1, further comprising a mesh surrounding the at least one module.

10. A collapsible sail system, the collapsible sail system comprising:
(a) at least one hinge unit; and
(b) at least one sail with a convex face and a concave face, wherein the hinge unit contains at least one hinge wherein the at least one sail moveably interfaces, whereby the hinge unit allows for the sails to collapse when incoming wind contacts the convex face and allows for the sails to fully extend when incoming wind contacts the concave face.

11. The collapsible sail system of claim 10, wherein the at least one sail is made of a material selected from the group consisting of metal, plastic, rubber, wood, alloys, polymers and combinations thereof.

12. The collapsible sail system of claim 10, wherein the at least one hinge unit is made of a material selected from the group consisting of metal, plastic, rubber, wood, alloys, polymers and combinations thereof.
